(19) United States
(12) Patent Application Publication
(10) Pub. No.: US 2007/0026095 A1
(43) Pub. Date: Feb. 1, 2007

(54) Tobacco reconstitution

(75) Inventors: William David Lewis, Southampton (GB); Humberto Conti, Southampton (GB); Roy Lester Prowse, Hants (GB)

Correspondence Address: PITNEY HARDIN LLP, 7 TIMES SQUARE, NEW YORK, NY, 10036-7311, US

(73) Assignee: British American Tobacco (Investments) Limited

(21) Appl. No.: 11/528,764

(22) Filed: Sep. 28, 2006

Related U.S. Application Data
(62) Division of application No. 10/276,143, filed on Sep. 29, 2003.

(30) Foreign Application Priority Data
May 12, 2000 (GB) 0011351.4

(51) Int. Cl. B29C 47/00

(52) U.S. Cl. 425/131.1

(57) ABSTRACT

The invention relates to the extrusion of filamentary strands of reconstituted tobacco through a die plate and the downstream handling thereof. The die plate is configured such that each filament is of a square or rectangular cross-section, the downstream handling of which effects draw down of the extruded filament.

This application is a division of Ser. No.: 10/276,143, filed on Nov. 12, 2002, which in turn is a 371 of International Application No.: PCT/GB01/01838 filed May 8, 2001, both of which are incorporated herein by reference.

### FIELD OF THE INVENTION

The present invention relates to tobacco reconstitution and particularly to the extrusion of filamentary strands of reconstituted tobacco. More specifically the present invention relates to the treatment of filamentary strands of reconstituted tobacco downstream of a tobacco reconstitution extruder.

### BACKGROUND OF THE INVENTION

There have been many prior proposals for the production of tobacco based material utilising particulate tobacco. According to these proposals, the particulate tobacco may be tobacco dust inadvertently produced during smoking article manufacturing processes, cigarette manufacturing processes for example, or may be obtained by grinding tobacco leaf lamina or stem portions. The materials produced from the particulate material may take the form of flat webs or sheets, rods, filaments or hollow cylinders. Processes producing these materials are commonly referred to as tobacco reconstitution processes.

Components additional to tobacco which have been proposed for inclusion in materials produced by reconstitution processes are water; binding agents, e.g. pectin, starch, pullulan and cellulosic binders; fillers; humectants; expansion agents; reinforcing agents; and flavourants.

A prior proposed reconstituted tobacco process by the applicant was disclosed in UK Patent Specification Nos. 2 201 081B and 2 201 080B. The process involved feeding a mixture of particulate tobacco, starch and binder, with the addition of water to an extruder to provide a sheet form extrudate, the extrusion being carried out under such conditions that the extrudate assumes a cross-section greater than that of the exit orifice of the extruder die, i.e. undergoes an expansion process. It was suggested that it is advantageous to draw down the sheet form extrudate, so to effect an increase in the machine direction dimension of the extrudate and a decrease in the thickness thereof.

A further reconstituted tobacco process is disclosed in GB 2 291 778B.

A disadvantage of the reconstituted tobacco processes described in these patent specifications is that production of sheet material can be problematic. For example, the thickness, strength and elasticity of the sheet material may be difficult to regulate and if any of these parameters is outside of tolerance limits downstream manipulation of the sheet material (i.e. through cutters) can be adversely affected.

A further disadvantage of this prior art reconstituted tobacco process is that once cold the resultant sheet product has an upper skin and a lower skin with a honeycomb structure therebetween. Thus degradation of the product may occur at transverse faces of the product, i.e. faces not constituted by a skin. Thus the product is frangible. It is, therefore, undesirable or practically impossible to pneumatically convey such a product.

U.S. Pat. No. 4,632,131 discloses the extrusion of strands or filaments of reconstituted tobacco wherein a plurality of strands are extruded from a die, comprising a circular array of exit orifices, and are subsequently adhered to one another so as to form a reconstituted tobacco rod having passageways extending generally longitudinally thereof.

A disadvantage of such strand extrusion methods for reconstituted tobacco, when it is required to produce discrete strands, is that the strands exiting the exit orifices of the extruder die are difficult to handle without the strands becoming co-adhered.

### SUMMARY OF INVENTION

An object of the present invention is to provide an improved method of manufacture of extruded, filamentary, reconstituted tobacco.

A further object of the present invention is to provide an improved method of handling an extruded, reconstituted tobacco filament downstream of an exit orifice of the extruder.

A yet further object of the present invention is to provide an improved filamentary reconstituted tobacco product.

An even yet further object of the present invention is to provide a reconstituted tobacco product of appropriate dimensions for incorporation into a smoking article, i.e. a cigarette.

### BRIEF DESCRIPTION OF DRAWINGS

In order that the present invention may be clearly understood and readily carried into effect reference will now be made, by way of example, to the diagrammatic drawings hereof, in which:

FIG. 1 shows an apparatus suitable for carrying out the method of the present invention;

FIG. 2 shows an alternative apparatus suitable for carrying out the method of the present invention; and

FIG. 3 shows a view of the front face of an extrusion die and the exit orifices thereof.

Wherever possible reference numerals in respect of each part of the apparatus shown in the figures have been conserved between the figures.

### DETAILED DESCRIPTION OF THE INVENTION

The present invention provides a method of handling an extruded reconstituted tobacco filament downstream of die means through which said filament is being extruded, wherein said filament is transferred in a direction longitudinal of said filament away from said die by pneumatic conveyance means, said conveyance means effecting draw down of said filament such that the cross-sectional dimensions of said filament are reduced.

Advantageously, the method may further comprise a cutting step, in which step the extruded filament is cut transversely at intervals along the length thereof into a plurality of elements. For example, the filament may be cut at intervals in the range of about 10 mm to about 50 mm. Preferably, the extruded filament is cut subsequent to the reduction in the cross-sectional dimensions of the filament. The cutting means utilised in the cutting step may suitably be a rotary cutter.

Advantageously in some instances the method may further comprise a cooling step, whereby cooling air is brought into contact with the extruded filament to effect cooling thereof. The temperature of the extruded filament at the cutting means, when present, should advantageously be low enough to ensure that the extrudate is insufficiently tacky to cause problems in the operation of the cutter means. Suitably, the temperature of the extruded filament at the cutting stage is within the range of about 20° to about 60° Celsius, preferably with the range of about 30° to about 50° Celsius.

Preferably, the pneumatic conveyance means comprises a gaseous medium transfer means and duct means, the transfer means being operable to cause transfer of gaseous medium, as a continuous flow thereof, through the duct means. The gaseous medium transfer means may comprise, for example, suction means, which suction means may suitably be provided by fan means. Preferably, the inlet end of the duct means is positioned adjacent to the extruder die such that when the filament emerges from the die orifice the filament is readily transferred in a direction longitudinal of the filament away from the die under the action of the continuous flow of gaseous medium through the duct means. Advantageously the inlet end of the duct means is located within about 5 mm about 20 mm from the extruder die, and preferably within the range of about 10 mm-about 15 mm. The transfer in a direction longitudinal of the filament is advantageously initially perpendicular to the die face. Thereafter the transfer may be in a substantially horizontal or vertical plane.

In normal practice the gaseous medium will be air, and thus air only is referred to hereinbelow.

The draw down of the filament, to reduce the cross-sectional dimensions thereof, is effected by the velocity of the air flowing in a direction which corresponds with the transfer direction of the filament being greater than the extrusion velocity. Therefore, the filament downstream of the extruder die is tensioned and drawn down by the air. Draw down may be enhanced by tensioning the filament further by drawing the filament over a tensioning means. The tensioning means may be, for example, a driven roller.

Draw down is effected advantageously by an air velocity in the range of 60-180 m/s, and is preferably at least 100 m/s. The drawn down velocity required is dependent on the formulation chosen and the throughput selected in the extruder. The air velocity can be varied using the suction means, the cross-sectional area of the duct, or both. The conveying velocity after draw down is suitably in the range of 30-60 m/s, and is preferably at least 35 m/s, and more preferably in the range of 40-60 m/s.

Much to be preferred is a pneumatic conveyance means configuration and the selection of a mass airflow value which ensure that the filament(s) does not in its transference through the duct means come into contact with any inner surface of the duct means.

Much by preference the cross-sectional shape of the extruded reconstituted tobacco filament resemble the cross-sectional shape of cut tobacco, particularly cut lamina tobacco. In order to achieve this resemblance the extruded tobacco filament should be of a substantially rectangular or square cross-section. Expansion of the extrudate may occur upon exit thereof from the extruder die. Therefore, in a case when expansion of the extrudate occurs, in order to provide an extruded filament of a rectangular or square cross-section, the exit orifice of the die should be of a generally square or rectangular configuration, the sides of the square or rectangle being concave. By use of an appropriate concavity in relation to the degree of expansion of the extrudate there may be produced a filament the cross-sectional shape of which is a substantially straight sided square or rectangle.

The cross-section of a filament following draw down thereof, advantageously has dimensions of about 0.7 mm×about 1 mm, preferably of about 0.3 mm×0.8 mm. Suitably the filament has a length, post-cutting, in a range of about 10 mm to about 50 mm. By use of the present invention, the beneficial result of a filament of constant cross-sectional dimensions post-draw down is achieved.

The resultant filamentary reconstituted tobacco product consists of lengths of a filament comprising a cellular interior and an integral skin extending over, when the filament is of a square or oblong cross-section, at least the four longitudinal sides of the filament. This structure provides a strong product, which product can be subsequently transported pneumatically without being substantially degraded.

The product has a filling value in the range of about 3.8 to about 5.0 mm³/mg, and may suitably be in the range of about 4.0 mm³/mg-about 4.6 mm³/mg. This represents the potential for an increase in filling value of 10-20% over the filling value of products produced in accordance with the processes described in UK Patent Specification Nos. 2 201 081B and 2 201 080B. The product density may be in the range of about 150 mg/mm³ to about 600 mg/mm³, and preferably less than about 400 mg/mm³.

In normal practice, a reconstituted tobacco product manufactured by means of the present invention will form a proportion of a cigarette filler blend, other tobacco constituents of which blend may be, or include, cut lamina and cut stem.

Much by preference, a plurality of reconstituted tobacco filaments are co-extruded. Suitably, when it is the case that a plurality of filaments are co-extruded, a die comprising a plurality of exit orifices is employed. Preferably, the exit orifices of such an extrusion die are arranged in such a manner that the filaments issuing therefrom are in a side-by-side, advantageously horizontal, array. It is preferable that each filament of the plurality of filaments is maintained out of contact with each of the other filaments. Thus, adherence of the filaments one with another is avoided.

The present invention also provides an extruder die plate, the die plate comprising die orifices, the die orifices being of a generally square or rectangular configuration, and the sides of the square or rectangle being concave.

Suitably, the exit face of the die is oblong in configuration and the exit orifices thereat are arranged in a single row across the face. Alternatively, the exit orifices may be arranged in two, upper and lower, longitudinal rows across the face, the orifices of the upper row being vertically out of registration with the orifices of the lower row. Suitably, when a plurality of filaments is extruded, the duct of the pneumatic conveyance means may be of an oblong cross-section so as to enable the plurality of filaments to travel side-by-side of one another through the duct. The number of orifices in the die is selected in accordance with the desired throughput from the extruder.

Preferably, the extrusion mixture comprises particulate tobacco, starch and binder. Water is preferably added to the above mixture when the mixture is in the barrel of the extruder.

The starch is preferably present in the tobacco/starch/binder mixture at a level within the range of about 5% to about 35% by weight and preferably within a range of about 10% to about 20% by weight. The starch is preferably present in the mixture in an amount by weight exceeding that of binder by two times and more preferably by three or more times. The level of binder in the mixture preferably does not exceed 10% by weight and more preferably does not exceed 5% by weight.

The starch may, for example, be maize or corn starch. The starch, or a proportion thereof, may be a modified starch.

Suitably the binder comprises a cellulosic binder. Cellulosic binder materials for use in practising the present invention may be hydroxypropyl cellulose, carboxymethyl cellulose, hydroxyethyl cellulose, methyl cellulose and ethyl cellulose. Other binders suitable for use in practising the present invention include gums, such as xanthan gum, guar gum and locust bean gum. Further suitable binder materials will readily occur to those skilled in the art. Binder of the mixture may be provided by two or more binder materials.

Binders of lesser quality, i.e. those which tend to be less expensive can be used in the present invention vis-á-vis the high quality binders which are typically required in reconstituted tobacco products as disclosed in GB 2 201 080. Alternatively, lower quantities of the high quality binder may be used in the present invention. The requirement for a lower quality binder and/or a lower quantity of binder for use in the present invention is predicated upon the fact that the resultant particulate filamentary reconstituted tobacco product of the present invention comprises a cellular interior with an integral skin extending over, when the particle is a square or oblong cross-section, at least the four longitudinal sides of the particle. This contrasts with the sheet reconstituted tobacco product of GB 2 201 080 which comprises merely an upper skin and a lower skin with a honeycomb structure therebetween.

Furthermore, as mentioned above the increase in filling value obtaining with product produced according to the invention provides the possibility of decreasing the amount of binder in the formulation, whilst maintaining a comparable filling value to the product described in GB 2 201 080B.

In addition to tobacco, starch and binder, sugar may be fed to the extruder. The sugar, if present, may comprise one or more sugars, such for example as fructose, glucose or sucrose. Suitably, the sugar is present at a level not exceeding about 5% by weight of the tobacco/starch/binder mixture, but may be present up to a level of about 10%.

Advantageously, the total water present in the extruder is such that, without an extrudate drying step being utilised, the moisture content of the filament post-draw down is within a range of about 5% to 20% by weight (wet basis). By “total water” is meant the sum of any moisture present in the “dry” components of the tobacco/starch/binder mixture and any added water. Water may be added to one or more of the components of the mixture before the components are fed to the extruder and/or by way of injection via a barrel port(s) of the extruder barrel. A convenient practice is to mix the components of the mixture and then to feed the mixture in a dry or substantially dry state to the extruder, water being added by injection into the extruder barrel.

Suitably, a humectant and/or plasticiser, such as for example glycerol or propylene glycol is fed to the extruder with the components of the above referred to mixture and/or by way of injection into the extruder barrel. The inclusion level of the plasticiser may be within a range of about 1 to about 10% by weight on a wet basis.

Advantageously, filaments with optimised characteristics are obtained by ensuring that the processing within the extruder of the materials fed thereto takes place adiabatically or close to adiabatically. It is also important to operate with an extruder barrel temperature profile up to the extruder die such that the temperature of the tobacco portion of the materials in the extruder does not attain a value which would be deleterious to the tobacco and is suitably in a range of about 80° Celsius to about 180° Celsius.

Advantageously, the processing takes place under such conditions that immediately upon it issuing from the die, the extrudate is expanded by water therein flashing off to steam. There is thereby effected an increase in the cross-section of the extrudate and the establishment of a cellular interior structure.

As will be readily appreciated by those skilled in the tobacco reconstitution art, possibilities arise for feeding flavourant materials to the extruder. Such materials may be nature-identical or artificial flavourants or botanical extracts.

The particulate tobacco used in the subject inventive process can be derived from the stem and/or the lamina portions of tobacco leaf, for example tobacco dust. The particle size of the particulate tobacco is preferably less than about 500 μm, and is more preferably less than about 370 μm. Particle size will usually be determined by the smallest dimension of the die orifice.

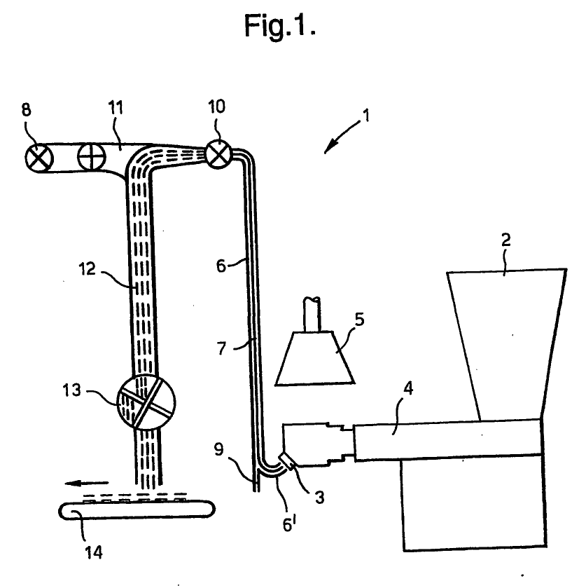

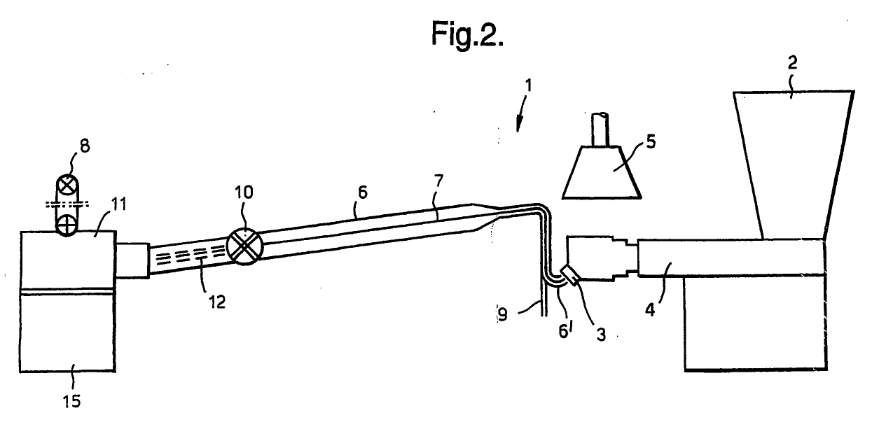

As shown in FIG. 1, the apparatus 1 comprises a twin-screw extruder 2 (manufactured by APV Baker, of Peterborough, U.K., under Model designation number MPF50-15) including a die 3 and a barrel 4. The extruder die 3 is mounted at the outlet end of the barrel 4 of the extruder 2. A steam extraction unit 5 is located above the extruder die 3 and is operable to remove steam issuing from the die 3 during the extrusion process. The apparatus 1 further comprises pneumatic conveyance means including a gaseous medium (i.e. air) duct means 6 extending from a position adjacent to the extruder die 3, and gaseous medium transfer means 8. As may be seen from FIGS. 1 and 2, the duct means 6 comprises at the upstream end thereof a curved inlet portion 6′. The duct means 6 is of an oblong cross-section, the major dimension of the cross-section extending perpendicularly to the view depicted in FIG. 1. The gaseous medium transfer means 8 comprises suction means provided by a suction fan. A cool air intake port 9 is in communication with the duct means 6 at the lower end thereof, which air intake port 9 is operable to allow cooling air to be drawn into the duct means 6. A cutting means 10, i.e. a rotary cutter, is situated in the duct means 6 and is operable to cut the extruded reconstituted tobacco filaments 7 into particles of filamentary reconstituted tobacco product 12. Incorporated in the duct means 6 is a particle/air separator 11 whereby air flowing through duct means 6 is separated from the particles of filamentary reconstituted tobacco product 12 and any other particulate matter being conveyed through the duct means 6. The filamentary tobacco product 12 is conveyed through an air lock 13, i.e. a rotary air lock, to feed means 14, which feed means 14 conveys the filamentary tobacco product 12 to a silo (not shown).

In FIG. 2 an alternative apparatus to that of FIG. 1 is shown, wherein the duct means 6 is orientated such that the filaments 7 are transferred in a direction longitudinal of the filaments 7 away from the die 3 in a substantially horizontal plane. This contrasts with the apparatus 1 of FIG. 1 in which the duct means 6 is orientated such that the filaments 7 are transferred, at least over a portion of the duct means 6, in a substantially vertical plane. The apparatus of FIG. 2 otherwise resembles that depicted in FIG. 1 excepting that in FIG. 2 the apparatus I comprises a storage container 15, in to which container 15, in operation of the apparatus 1, cut product 12 is pneumatically conveyed.

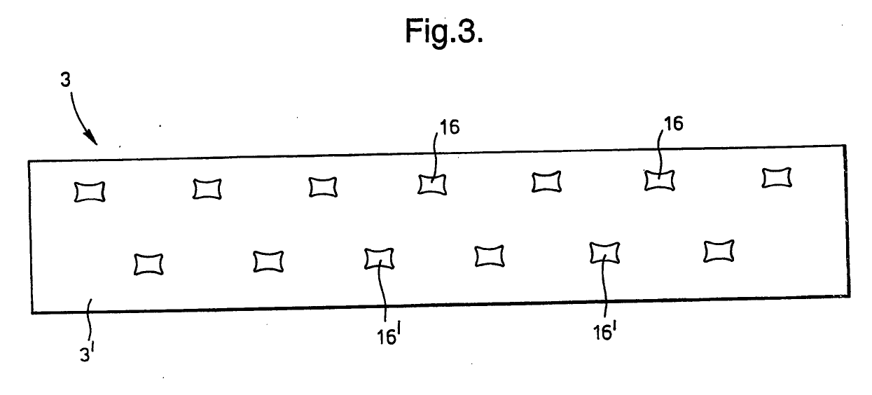

A view of the front face 3′ of the die 3 is shown in FIG. 3. As an be seen from FIG. 3, the die 3 is provided with a plurality of exit orifices 16, 16′. Only a small number of exit orifices 16, 16′ have been depicted in FIG. 3. However, the die 3 is, in fact, provided with a total of about one hundred exit orifices 16, 16′. Thus, a plurality of reconstituted tobacco filaments 7 are co-extruded. Each exit orifice 16, 16′ of the die 3 is of a generally square or rectangular configuration, the sides of the square or rectangle being concave. By use of an appropriate concavity in relation to the degree of expansion of the extrudate upon exit thereof from the die 3, there may be produced filaments 7 the cross-sectional shape of each being a substantially straight sided square or rectangle. The exit orifices 16, 16′ of the die 3 are arranged in such a manner that the filaments 7 issuing therefrom are in a side-by-side, horizontal array. Each filament 7 of the plurality of filaments 7 is maintained out of contact with each other of the filaments 7. The die 3 is of oblong configuration and the exit orifices 16, 16′ are arranged in two, upper and lower, longitudinal rows across the face 3′. The orifices of the upper row 16 are vertically out of registration with the orifices of the lower row 16′, as can be seen from FIG. 3.

In operation of either of the FIG. 1 or the FIG. 2 apparatus a dry mixture of 80% particulate tobacco dust, 15% starch and 5% cellulosic binder is fed at a rate of about 145 kg/hour to the extruder 2. A feed unit (not shown) of the extruder 2 serves to feed the mixture through a feed pipe (not shown) to the inlet end of the barrel 4 of the extruder 2. Water drawn from a tank (not shown) is injected at a rate of about 21 kg/hour into the barrel 4 under the action of a pump (not shown). Similarly, glycerol is drawn from a further tank (not shown) and is injected into the barrel 4 at a rate of about 5 kg/hour. The total water in the wet mix in the barrel 4 may, for example, represent 16% by weight of the wet mix.

The barrel 4 is provided with heating means (not depicted) by the operation of which a desired temperature profile can be maintained along the barrel 4. The barrel temperature may, for example, be maintained at 40° Celsius at the inlet end increasing to 95% Celsius at the outlet end.

The pressure within the extruder is maintained at a high enough value to ensure that water therein remains in the liquid phase. A pressure within the range of 500 psig (3,400 kPa or 34.5 Bar) to 2000 psig (13,600 kPa or 137.8 Bar) may thus be used, such as 1000 psig (6,800 kPa or 68.9 Bar) to 1500 psig (102,000 kPa or 103.4 Bar).

At these temperatures and pressures the starch fed to the extruder 3 is caused to gelatinise.

As the extruded filament 7 issues from the plurality of exit orifices 16, 16′, water therein flashes off to steam, as a result of which the cross-sectional shape of each filament changes due to expansion, such that the resultant cross-sectional shape of each filament 7 is a substantially straight sided square or rectangle when the shape of each exit orifice is as that shown in FIG. 3.

The approximately 100 co-extruded filaments 7 issue from the die 3 at a total mass rate of about 157 kg/hour, the linear speed of each extruded filament 7 being about 1 metre/second. The steam extraction unit 5 removes the flashed off steam.

The filaments 7 issuing from the orifices 16, 16′ are directed into the duct means 6 and are transferred through the duct means 6 in a direction longitudinal of the filaments 7 away from the die 3. Upon entry of the filaments 7 into the duct means 6, the filaments 7 become entrained in a continuous stream of air flowing through the duct means 6. Thus the filaments 7 are pneumatically conveyed through the duct means 6. The airflow in the duct means 6 is effected by the suction fan 8. During conveyance of the plurality of filaments 7 in the oblong duct means 6 each filament 7 of the plurality of filaments 7 is maintained out of contact with each other of the filaments 7. Thus, adherence of the filaments 7 one with another is avoided.

The filaments 7 are drawn down to reduce the cross-sectional dimensions thereof. The draw down is effected as a result of the velocity of the air flowing in the duct means 6 being greater than the extrusion velocity, which velocity differential engenders a drag force of the air on each of the filaments 7. Therefore, the filaments 7 downstream of the extruder die 3 are tensioned and thus drawn down by the air. By way of example, a velocity of the airflow which is effective to tension and draw down the filaments 7 is in the range of about 60 metres/second to about 180 metres/second when the extrusion velocity is about 1 metre/second. Such an airflow velocity is provided at least at an initial portion of the duct means 6, in order to effect draw down of the filaments 7 issuing from the orifices 16, 16′ of die 3. Draw down of the filaments 7 is effected until the required cross-sectional size of the filaments 7 is reached. The velocity of the airflow in the duct means 6 downstream of the initial draw down portion of the duct means 6 is suitably at least 35 metres/second, and may be about 50-60 metres/second. This reduction in airflow velocity is achievable by arranging that downstream of the draw down portion of the duct means 6, the cross-sectional area thereof is greater than at the draw down portion. A downstream airflow velocity such as 35 metres/second is suitable for transporting the filaments 7 without substantial draw down thereof. Thus the cross-sectional dimensions of the filaments 7 remain constant following the draw down step. The filaments 7 subsequent to draw down are conveyed at a rate of, for example, about 2 metres/second.

The filaments 7 are cut transversely at intervals of about 30 mm along the length thereof by the cutting means 10 thus to provide a product 12 constituted of filamentary particles of reconstituted tobacco. This cutting step takes place subsequent to the reduction in the cross-sectional dimensions of the filaments 7. The particulate product 12 is then pneumatically conveyed at about 20 metres/second either to an air lock 13 (FIG. 1) or directly to a storage container 15 (FIG. 2). Silo feed means 14 may be situated downstream of the air lock 13. The particles of the product 12 and the conveying air are separated by way of an air/particle separator 11.

The method may further comprise an enhanced cooling step, whereby cooling air is brought into contact with the extruded filament 7 to effect cooling thereof. The cooling air enters the duct means 6 through the cool air intake port 9. If deemed appropriate a plurality of cool air intake ports may be provided. Suitably, the cross-sectional area of the bore of the cool air intake port 9 is the same as that of the bore of the inlet portion 6′ of the duct means 6. Advantageously, the sum of the cross-sectional area of the intake port 9 and that of the inlet portion 6′ is equivalent to the cross-sectional area of the run of the duct means 6 extending immediately downstream of the inlet portion 6′. Preferably, the air flow through the cooling air intake port 9 is adjustable; for example a position adjustable baffle (not shown) may be located in the cooling air intake port 9, which baffle is operable to variably control the air flow rate through the intake port 9. Advantageously, the temperature of the filaments 7 at the cutting means 10 should be low enough to ensure that the extrudate does not foul the cutting means 10. The temperature of the filaments 7 at the cutting means 10 should be between 30° and 50° Celsius.

By way of example, the cross-sectional area of each of the intake port 9 and the inlet portion 6′ of the duct means 6 is in the range of about 10 cm² to about 20 cm², the cross-sectional area of the duct means 6 at the aforementioned initial draw down portion thereof is in the range of about 20 cm² to about 40 cm², and the cross-sectional area of the duct means 6 at the cutting means 10 is in the range of about 250 cm² to about 400 cm².

The cross-section of each filament 7, following draw down thereof, has dimensions of, for example, about 0.7 mm×about 1 mm. The particles of filamentary tobacco product 12 (i.e. the portions of the filament 7 post-cutting) are each of a length, for example, in the range of about 30 mm. The resultant filamentary reconstituted tobacco product 12 consists of particles each of which particles 12 is constituted by a length of a filament 7 and thus comprises a cellular interior and an integral skin extending over, when the particle is of a square or oblong cross-section, at least the four longitudinal sides of the particle.

The extruder may be any extruder suitable to provide a range of throughputs. The throughput may be up to 300 kg/hr, a suitable extruder for which throughput being the Buhler DNDG 62. Increasing the throughput of the extruder will require consequential increases in the gaseous medium transfer means, such as an increase in power of the suction fan up to about 75 kW—about 100 kW for a throughput of up to about 300 kg/hr. A throughput of about 150 kg/hr would require a suction fan of about 45 kW.

In an alternative arrangement of the subject invention the pneumatic conveyance means may additionally comprise pneumatic jet means. It is preferred that the pneumatic jet means are located adjacent to the extruder barrel such that when the filament emerges from the die orifice the filament is readily transferred in a direction longitudinal of the filament away from the die under the action of the continuous flow of gaseous medium provided by the pneumatic jet means, into and or through the duct means.

Alternatively, the pneumatic conveyance means may comprise compressed air jets. In this alternative arrangement of the subject invention, compressed air may be delivered from the compressed air jets in controlled pulses or as a continuous flow such that when the filament emerges from the die orifice, the filament is transferred in a direction longitudinal of the filament. The compressed air may be delivered so as to separate the filaments from one another and to transfer the filaments in a side-by-side array. It is preferred that the compressed air jets are arranged relative to the barrel of the extruder so as to provide compressed air substantially tangentially to the filament flow direction. Alternatively the compressed air jets may be arranged so as to deliver air through the die plate by means of at least one die orifice. It is preferred that the die orifices are other than those through which the filaments are extruded.

In a further alternative arrangement of the subject invention using compressed air jets the pneumatic conveyance means may optionally comprise the duct means.

The compressed air jets may be so arranged as to provide means for breaking the filaments into discrete elements of a controllable size and transferring the elements away from the die orifice.

In the arrangements of the subject invention using compressed air, the air is supplied at a pressure in the range of about 1 to about 200 bar, and is preferably in the range of about 5 to about 10 bar.

What is claimed:

1. An extruder die plate comprising die orifices, said die orifices being of a generally square or rectangular configuration, and the sides of the square or rectangle being concave, said orifices being arranged in one or more rows across the die face.

2. An extruder die plate according to claim 1, wherein said die orifices are arranged in a single row across said die face.

3. An extruder die plate according to claim 1, wherein said die orifices are arranged in two rows across said die face.

4. An extruder die plate according to claim 1, wherein said die orifices are arranged in such a manner that the extruded filaments issuing therefrom are in a side-by-side array.

5. An extruder die plate according to claim 1, wherein the exit face of said die plate is oblong in configuration.

6. An extruder die plate according to claim 1, wherein the die orifices are arranged in two, upper and lower, longitudinal rows, the orifices of the upper row being vertically out of registration with the orifices of the lower row.

7. An extruder die plate according to claim 2, wherein said die orifices are arranged in such a manner that the extruded filaments issuing therefrom are in a side-by-side array.

8. An extruder die plate according to claim 3, wherein said die orifices are arranged in such a manner that the extruded filaments issuing therefrom are in a side-by-side array.
